(19) United States
(12) Patent Application Publication
(10) Pub. No.: US 2026/0362564 A1
(43) Pub. Date: Nov. 12, 2026

(54) NO-NEUTRAL WI-FI SMART DIMMER DEVICE AND LOAD CONTROL SYSTEM

(71) Applicant: EATON INTELLIGENT POWER LIMITED, Dublin (IE)

(72) Inventors: Weihong Xie, Shenzhen (CN); Pankaj Nahar, Peachtree City, GA (US); Haidong Zhang, PuDong (CN); Hoon Lee, Sugar Hill, GA (US)

(73) Assignee: EATON INTELLIGENT POWER LIMITED, DUBLIN (IE)

(21) Appl. No.: 19/205,019

(22) Filed: May 12, 2025

(51) Int. Cl. H05B 45/10; H05B 47/19

(52) U.S. Cl. CPC H05B 45/10; H05B 47/19

(57) ABSTRACT

A wi-fi dimmer device is designed to be installed in homes having a no-neutral wiring configuration for lighting load circuits, the no-neutral wiring configuration being one in which each junction box in a lighting circuit only has a hot conductor wired to it and no neutral conductor. The wi-fi dimmer device includes a power supply circuit designed to ensure that the power provided to the control circuit of the dimmer device remains stable. The wi-fi dimmer device is further designed to auto-adjust its maximum dimming level as necessary to ensure that the power provided to the control circuit of the dimmer device remains stable and to prevent flickering of the connected light bulb load. The wi-fi dimmer device can also be implemented in a multi-device lighting control system with either an accessory dimmer or a three-way switch.

### FIELD OF THE INVENTION

The disclosed concept relates generally to dimmer switch systems, and in particular, to smart dimming systems and smart load control systems for buildings lacking a neutral conductor at their lighting circuit junction boxes.

### BACKGROUND OF THE INVENTION

In the U.S., homes built before the year 2011 were not required by the National Electric Code (NEC) to have neutral conductors run between locations (i.e. junction boxes) where switches were used to control lighting load circuits and the home's general-purpose power supply. FIG. 1 depicts a first wiring configuration 1 in a house wherein each junction box has a hot conductor and a neutral conductor run to it, and FIG. 2 depicts a second wiring configuration 2 in a house wherein each junction box has only a hot conductor run to it and no neutral conductor. The second wiring configuration 2 is sometimes referred to herein as the “no-neutral wiring configuration 2”. The first wiring configuration 1 is found in homes built in the year 2011 and later, while the second wiring configuration 2 can be found in homes built prior to the year 2011.

In both wiring configurations 1 and 2, there is a power source 3 (i.e. the home's general-purpose power supply, which is typically the utility grid), a light-producing bulb load 4, and a load control device 5. Common types of load control devices include dimmers and toggle switches, for example and without limitation. In the wiring configuration 1, the load control device 5 is installed in a junction box 6 to which both a hot conductor 8A and a neutral conductor 9 have been run from the power source 3, and a second hot conductor 8B runs from the load side of the junction box 6 to the bulb load 4. In contrast, in the wiring configuration 2, the load control device 5 is installed in a junction box 7 to which only a hot conductor 8A is run from the power source 3, i.e., there is no neutral conductor run to the junction box 7.

While the bulb load 4 always requires a neutral connection to the power source 3 so that there is a return path for current from the bulb load 4 to the power source 3, there is a difference in how that return path is formed in the wiring configuration 1 and the no-neutral wiring configuration 2. In the wiring configuration 1, because the neutral conductor 9 is connected between the junction box 6 and the power supply 3, the neutral conductor 10 of the bulb load 4 is routed to the junction box 6 in order to form a complete path by connecting to the neutral conductor 9. In contrast, in the wiring configuration 2, because there is no neutral path between the junction box 7 and the power supply 3, the return path for current from the bulb load 4 to the power source 3 is formed by routing the neutral conductor 10 of the bulb load 4 directly to the power source 3.

Smart electrical wiring devices are designed to keep the electrical connection to the home's general-purpose power supply (such as the power source 3 in FIGS. 1-2) closed at all times, so that the light bulb or other load connected to the smart wiring device can always be controlled remotely by a user and execute automated decision-making functions such as scheduling. That is, even when the light bulb or other connected load is off (e.g. the light bulb is not producing light), the electrical connection between the smart electrical wiring device and the home's power supply remains closed at all times, so that the remote or automated commands to turn the load on and off can be executed by changing the path and/or magnitude of power provided to electronic components in the smart wiring device that affect current flow to the load, rather than by physically opening and closing a manual switch that either opens or closes the current path between the wiring device and the power supply. In contrast, non-smart electrical wiring devices are controllable solely via manual actuation of a physical toggle switch or dimming button, and turning the light bulb or other connected load off and on is achieved by actuating the toggle switch or dimming button to either physically open or physically close the electrical connection between the home's power supply and the electrical wiring device.

In a smart dimmer device, there is a control module that implements the smart functionality, and the control module itself consumes power and thus needs to form a closed current path with the power source 3. In the wiring configuration 1 shown in FIG. 1, the control module of a smart dimmer device installed in the junction box 6 can form a circuit with the power source 3, as the smart wiring device can be connected in series between the hot conductor 8A and the neutral conductor 9 to form a closed current path. In contrast, the control module of a smart dimmer device installed in the junction box 7 (FIG. 2) is unable to form a circuit with the power source 3 directly from the junction box 7, due to the lack of a neutral conductor between the junction box 7 and the power source 3. Although there are smart dimmer products that have been designed to address the lack of a neutral conductor at junction boxes 7 in homes having the wiring configuration 2 by using the bulb load 4 to form a neutral return path from the smart dimmer to the power source 3, the impedance of the bulb load 4 causes these smart dimmer products to have diminished performance compared to their counterparts designed for use in homes having the wiring configuration 1, as will become apparent later herein.

There is thus room for improvement in smart dimmer devices and systems designed for installation in junction boxes having no-neutral electrical wiring configurations.

### SUMMARY OF THE INVENTION

These needs, and others, are met by a wi-fi dimmer device designed to be installed in homes having a no-neutral wiring configuration for lighting load circuits, the no-neutral wiring configuration being one in which each junction box in a lighting circuit only has a hot conductor wired to it and no neutral conductor. The wi-fi dimmer device includes a power supply circuit designed to ensure that the power provided to the control circuit of the dimmer device remains stable. The wi-fi dimmer device is further designed to auto-adjust its maximum dimming level as necessary to ensure that the power provided to the control circuit of the dimmer device remains stable and to prevent flickering of the connected light bulb load. The wi-fi dimmer device can also be utilized in a multi-device lighting control system with either an accessory dimmer or a three-way switch.

In one embodiment of the disclosed concept, a smart dimmer is structured to be connected between a power source that provides an AC source voltage signal and a bulb load that produces light, the bulb load being connected to the power source by a neutral conductor. The smart dimmer comprises a control board and a power board. The control board includes a control module that comprises a controller, a wi-fi module, and a board to board connector that connects the control board to the power board. The power board has a line side and a load side and is structured to receive the AC source voltage signal as input to its line side and to be connected at its load side to the bulb load. The power board comprises: a zero-crossing detection circuit; a TRIAC gate control; a TRIAC device; a snubber circuit configured to receive the AC source voltage signal as input and to output a transient-suppressed voltage signal; a bridge rectifier configured to receive the transient-suppressed voltage signal as input and to rectify the transient-suppressed voltage signal to produce a rectified voltage signal Vrect; a rectified voltage monitor circuit configured to determine the magnitude of Vrect; a flyback converter configured to receive Vrect as input and to output a flyback DC signal; and a buck converter configured to receive the flyback DC signal as input and produce a DC supply signal to power the control module. The zero-crossing detection circuit, the rectified voltage monitor circuit, and the buck converter are all configured to provide input signals to the controller. The controller is configured to: set a dimming level for the bulb load; detect zero crossings in the AC source voltage signal; and provide input signals to the TRIAC gate control to turn on and turn off the TRIAC device at specific points after the zero crossings in order to cause current to flow to the bulb load to produce a light output corresponding to the dimming level.

In another embodiment of the disclosed concept, a method of dimming a bulb load with a smart dimmer in a lighting circuit is provided. The lighting circuit includes a power source, a bulb load, and the smart dimmer, with the bulb load being connected to the power source via a neutral conductor and the smart dimmer not being structured to have a direct neutral connection to the power source while connected to the bulb load. The smart dimmer has a control module including a controller. The method comprises: connecting the smart dimmer between the power source and the bulb load, by connecting a line terminal of the smart dimmer to line voltage of the power source and by connecting a load terminal of the smart dimmer to the bulb load; initializing the smart dimmer; determining, with the controller, a minimum threshold safety value Vthresh for a rectified voltage Vrect produced in the smart dimmer; setting, with the controller, a maximum conduction angle for the smart dimmer based on the value of Vthresh; monitoring Vrect with the controller; determining, with the controller, if Vrect has decreased to Vthresh; and setting the maximum conduction angle to the present value of Vrect when Vrect decreases to Vthresh. Vthresh is the minimum value that Vrect can take that enables the control module to operate stably. The initializing includes: closing an electrical path between the power source, the bulb load, and the control module of the smart dimmer; and determining a number of constant operating attributes of the lighting circuit with the controller.

### BRIEF DESCRIPTION OF THE DRAWINGS

A full understanding of the invention can be gained from the following description of the preferred embodiments when read in conjunction with the accompanying drawings in which:

FIG. 1 is a simplified schematic diagram of a first type of wiring configuration found in homes, in which both a hot conductor and a neutral conductor are wired to each junction box in lighting circuits;

FIG. 2 is a simplified schematic diagram of a second type of wiring configuration found in homes, a no-neutral wiring configuration, in which only a hot conductor is wired to each junction box in lighting circuits, with no neutral conductor being wired to the junction box;

FIG. 3 is a block diagram of the architecture of a known smart dimmer device connected to the wiring of a home having the no-neutral wiring configuration of FIG. 2;

FIG. 4 is a graph of voltage waveforms showing the inverse relationship between power supplied to the control circuit and the dimming level output by the dimmer device of FIG. 3;

FIG. 5 is a block diagram of the architecture of an innovative wi-fi dimmer device designed to be installed in homes having the no-neutral wiring configuration of FIG. 2, in accordance with an example embodiment of the disclosed concept;

FIG. 6 is a graph of voltage waveforms showing the relationship between power supplied to the control circuit and the dimming level output by the dimmer device of FIG. 5;

FIG. 7 is a schematic diagram of a non-isolated implementation of a voltage monitor circuit of the dimmer device of FIG. 5, in accordance with an example embodiment of the disclosed concept;

FIG. 8 is a schematic diagram of an isolated implementation of the voltage monitor circuit of the dimmer device of FIG. 5 utilizing a comparator with an opto-coupler, in accordance with an example embodiment of the disclosed concept;

FIG. 9 is a schematic diagram of another isolated implementation of the voltage monitor circuit of the dimmer device of FIG. 5 utilizing transistors with an opto-coupler, in accordance with another example embodiment of the disclosed concept;

FIG. 10 is a flow diagram of a method of dimming a load with a no-neutral smart dimmer, in accordance with an example embodiment of the disclosed concept;

FIG. 11 is a wiring diagram for an improved dimmer system that uses the wi-fi dimmer device of FIG. 5 and an accessory smart dimmer, for homes having the no-neutral wiring configuration of FIG. 2, in accordance with an example embodiment of the disclosed concept;

FIG. 12 is a block diagram showing the architecture of the wi-fi dimmer and the accessory smart dimmer in the dimmer system of FIG. 11;

FIG. 13 is a wiring diagram for an improved dimmer system that uses the wi-fi dimmer device of FIG. 5 and a three-way switch, for homes having the no-neutral wiring configuration of FIG. 2, in accordance with another example embodiment of the disclosed concept; and

FIG. 14 is a block diagram showing the architecture of the wi-fi dimmer and the three-way switch in the dimmer system of FIG. 13.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

As employed herein, the term “controller” shall mean a programmable analog and/or digital device that can store, retrieve, and process data; a microprocessor; a microcontroller; a microcomputer; a central processing unit; or any suitable processing device or apparatus.

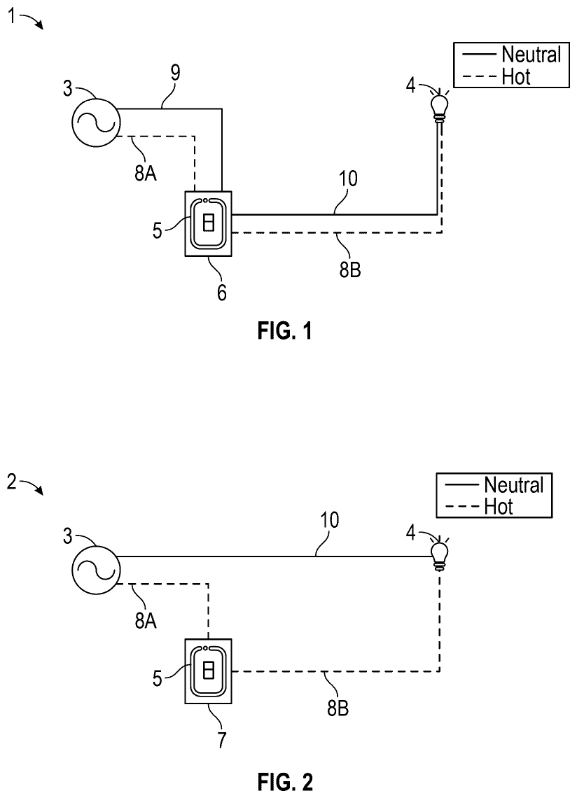

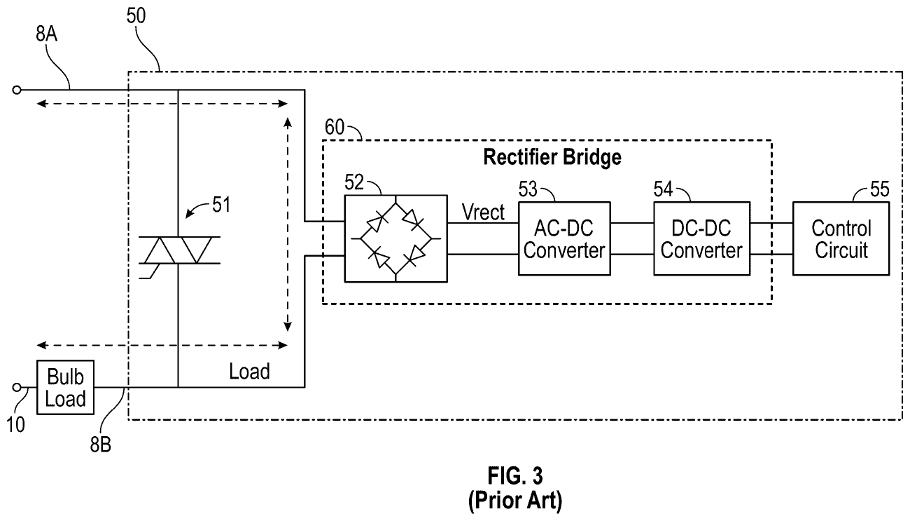

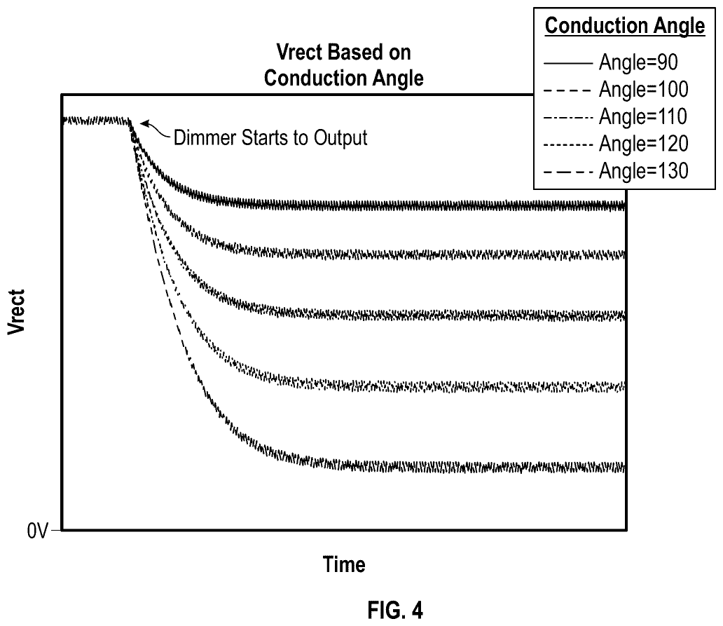

As noted previously herein, there are smart dimmer products available for use in homes having the no-neutral wiring configuration 2 (FIG. 2), but these products have diminished performance compared to their counterparts designed for use in homes having the wiring configuration 1 (FIG. 1). A short discussion of these products will now be provided with reference to FIGS. 3-4 prior to detailing the claimed invention, in order to provide context for the innovative nature of the claimed invention. FIG. 3 is a block diagram of a known smart dimmer 50 connected to the wiring of a home having the no-neutral wiring configuration 2 of FIG. 2. The known smart dimmer 50 has architecture representative of the architecture typically used in smart dimmer products designed for use in homes having the no-neutral wiring configuration 2. The known smart dimmer 50 comprises a TRIAC 51, a rectifier bridge 52, an AC-DC converter 53, a DC-DC converter 54, and a control circuit 55 all connected between the hot conductor 8A and the load conductor 8B. The rectifier bridge 52, AC-DC converter 53, and DC-DC converter 54 can be referred to as the power supply circuit 60 for the control circuit 55, as the power supply circuit 60 converts the AC power supplied through the hot conductor 8A to DC power of a magnitude suitable for use by the control circuit 55.

Among known no-neutral smart dimmers such as the known smart dimmer 50, when the no-neutral smart dimmer is intended to enable wi-fi communication with a user, such communication is typically facilitated via a wi-fi hub that is a discrete component separate from the smart dimmer 50 itself, with the control circuit 55 being configured to connect to and communicate with the wi-fi hub in order to receive and transmit communications to a user. In such a setup, the control circuit 55 can receive user input (e.g., input communicated via a smartphone app) and controls the TRIAC 51 to actuate dimming of the bulb load 4 in accordance with the input received. Aside from facilitating communication between a remote user and the smart dimmer 50, the control circuit 55 can be configured to implement automated smart functions such as scheduling or group control.

When the TRIAC 51 is OFF (i.e. due to zero voltage being applied to its gate), no current flows through the bulb load 4 and the bulb load 4 is de-energized. When the TRIAC is ON (i.e. due to a sufficient voltage greater than or equal to its threshold voltage being applied to its gate), current flows through the bulb load 4 and the bulb load 4 produces light. The earlier in the AC voltage cycle that the switch of the TRIAC 51 is turned on, the longer current takes to flow to the bulb load 4 and the brighter the light output is. Conversely, the later in the AC voltage cycle that the switch of the TRIAC 51 is turned on, the longer that current takes to flow to the bulb load 4 and the dimmer the light output is.

There are some performance limitations that arise from the setup shown in FIG. 3. Because the input current to the power supply circuit 60 should flow through the bulb load 4, the input current to the power supply circuit 60 is limited by the impedance of the bulb load 4 (i.e. the load power of the bulb load 4). In addition, the input voltage is phase-cut and limited by the conduction angle of the TRIAC 51 (the conduction angle being determinative of the dimming level). Thus, the input voltage Vrect to the AC-DC converter 53 decreases when the dimmer 50 starts to output, and the final value of Vrect changes as the conduction angle of the TRIAC 51 changes. That is, the brighter the dimming level that the dimmer 50 is set to by the control circuit 55, the lesser Vrect is and the lesser the power supplied to the control circuit 55 is. However, the current consumption needs of the control circuit 55 are essentially stable once the bulb load 4 is wired to the dimmer 50, as the impedance to the circuit 55 is based on the impedance of the light fixture load 4. As such, the inverse relationship between the power supplied to the control circuit 55 and the dimming level of the dimmer 50 causes foreseeable performance issues when the dimming level is set to high levels, as the control circuit 55 may not receive sufficient power to fully power its electronic components in order to properly function to execute automated functions and/or maintain its wi-fi communication capability. This inverse relationship between the power supplied to the control circuit 55 and the dimming level of the dimmer 50 is depicted in FIG. 4 and is a defining characteristic of TRIAC-based dimming in known no-neutral smart dimmers.

### System Architecture Of A No-Neutral Wi-Fi Smart Dimmer

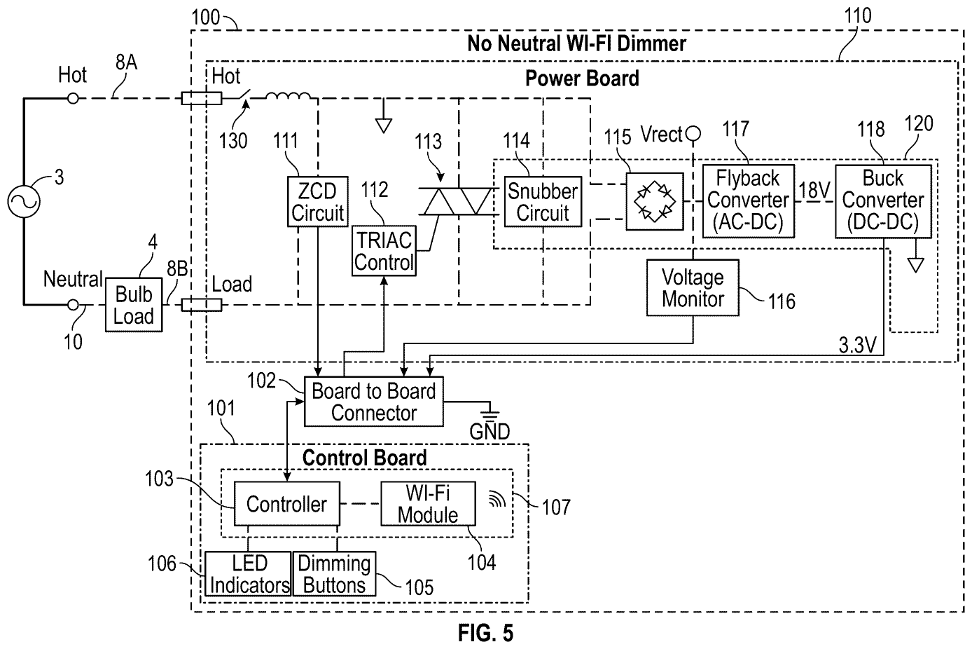

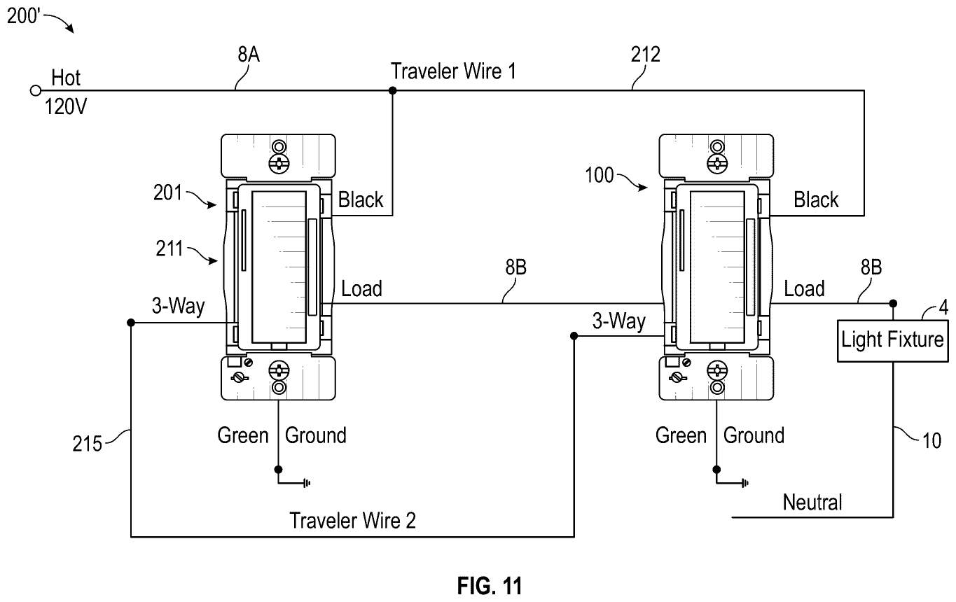

FIGS. 5-10 depict various aspects of an innovative improved no-neutral wi-fi smart dimmer 100 having a novel architecture that eliminates performance issues known to arise in existing no-neutral dimmer devices such as the dimmer 50 shown in FIG. 3. FIGS. 11-14 depict embodiments of a no-neutral dimmer system 200 that include the innovative no-neutral wi-fi smart dimmer 100. As an initial matter, it is noted that the terms “dim level” and “dimming level” are used interchangeably in the discussion of FIGS. 5-14.

Reference is now made to FIG. 5, which shows the overall system architecture of the improved no-neutral wi-fi smart dimmer 100, in accordance with an exemplary embodiment of the disclosed concept. The innovative no-neutral wi-fi smart dimmer 100 (referred to hereinafter as the “wi-fi dimmer 100” for brevity) shown in FIGS. 5-14 and detailed further hereinafter is designed to be installed and function consistently at an optimal level in homes having the no-neutral wiring configuration 2. It is noted that the wi-fi dimmer 100 has an on-board wi-fi module that eliminates the need to use a separate wi-fi hub.

As shown in FIG. 5, the wi-fi dimmer 100 is structured to be connected between the hot conductor 8A and the load conductor 8B, with a hot terminal of the wi-fi dimmer 100 being connected to the hot conductor 8A and a load terminal of the wi-fi dimmer 100 being connected to the load conductor 8B so that the bulb load 4 is connected on the load side of the wi-fi dimmer 100, in order to adjust power provided to the bulb load 4. It should be understood that the hot conductor 8A originates from the power source 3 (FIG. 2) and that the neutral conductor 10 of the bulb load 4 connects to the power source 3 to complete the circuit. The high-level structural organization of the wi-fi dimmer 100 includes a control board 101, a board to board connector 102, and a power board 110. The control board 101 includes components that enable wi-fi communication between an end user's remote device (e.g. via a software app) and the control board 101 to allow a user to remotely provide input to the wi-fi dimmer 100 in order to adjust dimming. The power board 110 both adjusts the power provided to the bulb load 4 based on signals transmitted by the control board 101 and provides a reliable power supply to the components of the control board 101 that consume power. The board to board connector 102 simply provides a communication interface between the control board 101 and the power board 110.

The control board 101 comprises a controller 103, a wi-fi module 104, a number of dimming buttons 105, and a number of LED indicators 106. While there can be more than one dimming button 105 and more than one LED indicator 106, these components are referred to hereinafter in the singular for the sake of simplicity. The controller 103 can constitute a microcontroller (denoted as “MCU” in some figures), for example and without limitation, and is in electrical communication with the wi-fi module 104 and dimming button 105. The controller 103 transmits control signals to the power board 110 in order to adjust the dimming of the bulb load 4, based on user input received via the wi-fi module 104 and the dimming button 105. The wi-fi module 104 enables a user to remotely provide input to the controller 103 via wireless communication. The dimming buttons 105 can be manually actuated by a user to provide input to the controller 103. The LED indicator 106 is controlled by the controller 103 to output various light signals indicating the state of the wi-fi dimmer 100, e.g., load on, load off.

The power board 110 comprises a zero-crossing detection (ZCD) circuit 111, a TRIAC gate control 112, a TRIAC device 113, a snubber circuit 114, a bridge rectifier 115, a rectified voltage monitor circuit 116, a flyback converter 117, and a buck converter 118. The ZCD circuit 111, the rectified voltage monitor circuit 116, and the buck converter 118 are all connected to the controller 103 in order to provide their outputs as input to the controller 103. The snubber circuit 114, the bridge rectifier 115, the flyback converter 117, and the buck converter 118 form a power supply circuit 120.

The power board 110 also comprises an air gap switch 130 that is structured to be manually actuated by a user to close and open the electrical connection between the wi-fi dimmer 100 and the power source 3. As noted previously herein, smart electrical wiring devices are designed to keep the electrical connection to the house's general-purpose power supply closed at all times and to adjust current provided to the connected load solely by changing the path and/or magnitude of power provided to electronic components in the smart wiring device that affect current flow to the load. As such, the air gap switch 130 must be closed in order for the wi-fi dimmer 100 to function, as the electrical connection between the wi-fi dimmer 100 and the power source 3 can only form when the air gap switch 130 is closed. It is expected that the air gap switch 130 would be kept closed at all times after installation and would only be opened when the wi-fi dimmer 100 needs to be serviced or uninstalled. It will be appreciated that the bulb load 4 can be turned off even when the wi-fi dimmer 100 is electrically connected to the power source 3, by controlling the electronic components of the power board 110, as detailed further hereinafter.

The ZCD circuit 111 is connected between the hot conductor 8A and the load conductor 8B to detect zero crossings in the AC source voltage signal provided by the power source 3. The controller 103 is connected to the TRIAC gate control 112 in order to provide or remove threshold voltage from the gate of the TRIAC device 113 to actuate switching of the TRIAC device 113 to its respective ON and OFF states, as dictated by user input regarding desired dimming levels provided to the controller 103 via the wi-fi module 104 or dimming button 105. The TRIAC device 113 is implemented in a known manner to control how power is supplied to the bulb load 4 in order to adjust the brightness of the output of the bulb load 4. When there is less than threshold voltage provided to the TRIAC device 113, the TRIAC device 113 is OFF such that no current flows to the bulb load 4, and the bulb load 4 does not produce light. When there is a voltage greater than or equal to threshold voltage provided to the TRIAC device 113, the TRIAC device 113 is ON such that current flows to the bulb load 4 and the bulb load 4 produces light. Because the voltage supplied by the power source 3 is AC voltage, for a given dimming level set by a user, the controller 103 is configured to adjust the gate voltage provided by the TRIAC gate control 112 to the TRIAC device 113 during every positive and negative half cycle of the AC source voltage signal in order to cause the bulb load 4 to output light at a constant brightness level for the set dimming level. The snubber circuit 114 suppresses undesirable voltage and current transients in the AC source voltage signal.

In the wi-fi dimmer 100, the wi-fi module 104 consumes the majority of the current supplied to the control board 101. Since there is no neutral wire to allow the current of the power supply circuit 120 to flow back to the power source 3, the bulb load 4 acts as the input resistor of the power supply circuit 120, resulting in the current capacity of the power supply circuit 120 to be very limited. The power supply circuit 120 is thus designed to ensure stable operation of the overall wi-fi dimmer 100 without any additional bypass circuits.

Because the controller 103 and wi-fi module 104 transmit the signals that control the dimming functions of the wi-fi dimmer 100, the controller 103 and wi-fi module 104 are sometimes collectively referred to hereinafter as the control module 107. The power supply circuit 120 provides the power required by the control board 101 (including the control module 107) and is detailed further hereafter. The bridge rectifier 115 is a full bridge rectifier and rectifies the transient-suppressed voltage signal output by the snubber circuit 114, the output of the bridge rectifier 115 being labeled Vrect in FIG. 5.

The rectified voltage Vrect is the input voltage to the flyback converter 117 and is mainly determined by four factors, including: (1) current draw of the control module 107, (2) efficiency of the power supply circuit 110, (3) impedance of the bulb load 4, and (4) the operating condition of the wi-fi dimmer 100 (operating condition meaning the dimming level). The current draw of the control module 107 and efficiency of the power supply circuit 110 are characteristics of the wi-fi dimmer 100 that are assumed to be always constant (i.e. whether or not a load is connected to the wi-fi dimmer 100), and once the bulb load 4 is correctly wired to the wi-fi dimmer 100, the impedance of the power supply circuit 110 is also assumed to be constant. Therefore, when the wi-fi dimmer 100 is properly installed within the non-neutral wiring configuration 2 with a bulb load 4 properly connected (i.e. as shown in FIG. 5), the single factor that determines the rectifier voltage Vrect is the operating condition of the wi-fi dimmer 100. Thus, under the conditions of the wi-fi dimmer 100 being properly installed within the non-neutral wiring configuration 2 with a bulb load 4 properly connected, it can be reasonably concluded that the rectifier voltage Vrect is proportional to the operating condition of the TRIAC device 113, since the dimming level output by the wi-fi dimmer 100 is directly based on the operating condition of the TRIAC device 113.

The flyback converter 117 is high efficiency and has a wide input range to convert the Vrect voltage to a first step down DC voltage. In the figures, the first step down DC voltage is indicated as being 18V, and this is a non-limiting illustrative example. The buck converter 118 reduces the first step down DC voltage to a lower output second DC voltage and increases current, in order to provide power of a suitable magnitude for use by the controller 103 and the wi-fi module 104 in the control module 107. For example and without limitation, many microcontrollers require 3.3V, so the lower output second step down DC voltage is indicated as being 3.3V in the figures as a non-limiting illustrative example of the voltage that is output by the buck converter 118 and suitable for use by the controller 103.

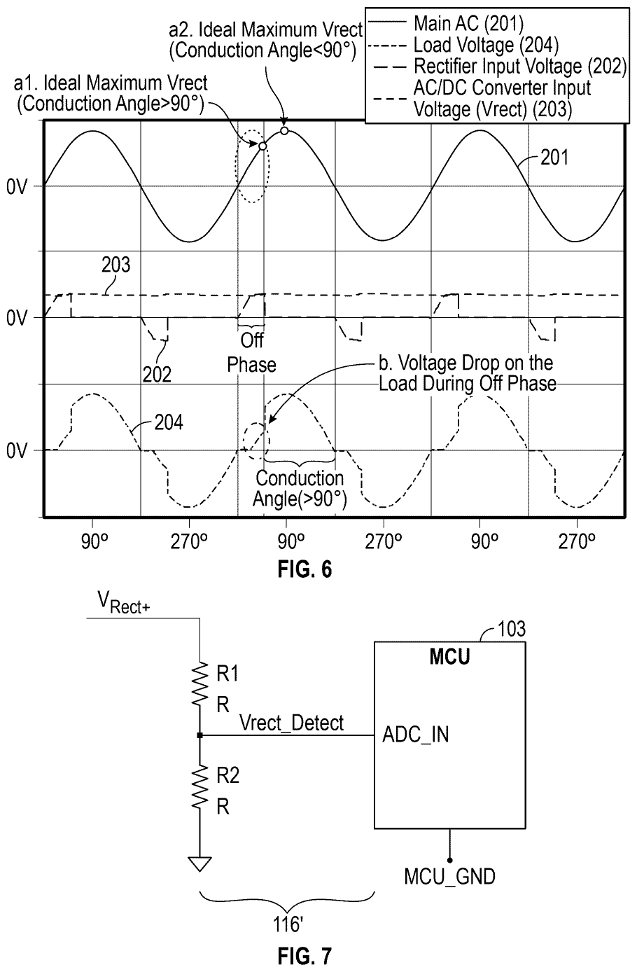

The rectified voltage monitor circuit 116 monitors the rectified voltage Vrect and the status of the flyback converter 117, and the controller 103 uses the output of the voltage monitor circuit 116 to ensure that the rectified voltage Vrect does not fall below a minimum threshold rectified voltage level Vthresh, which is achieved by ensuring that the dimming level of the wi-fi dimmer 100 remains under a maximum threshold dim level (as detailed further hereinafter in conjunction with FIGS. 6-10), due to the inverse relationship between Vrect and the dim level. For clarity, it is noted that when degrees of magnitude are used to describe the dim level herein, a higher dim level denotes a brighter output by the bulb load 4, and a lower dim level denotes a less bright output by the bulb load 4. As such, the term “maximum dim level” refers to the brightest output that can be produced by the bulb load 4 according to the present system constraints, and the term “minimum dim level” refers to the least bright output that can be output by the bulb load 4 according to the present system constraints. The controller 103 is configured to adjust the dim level of the wi-fi dimmer 100 as necessary in order to keep the rectified voltage Vrect sufficiently high to ensure the stable operation of the overall system of the wi-fi dimmer 100.

### Two-Wire Wi-Fi Dimmer Maximum Dim Level Auto-Adjust

Reference is now made to FIGS. 6-10 to detail the maximum dim level auto-adjust feature of the wi-fi dimmer 100, in accordance with an exemplary embodiment of the disclosed concept. FIG. 6 shows concurrent voltage waveforms of the utility power provided by the power source 3 (labeled “Main AC” and numbered with the reference number 201 in FIG. 6), the input voltage to the bridge rectifier 115 (labeled “Rectifier Voltage” and numbered with the reference number 202 in FIG. 6), the input voltage Vrect to the flyback converter 117 (labeled “AC/DC Converter Input Voltage (Vrect)” and numbered with the reference number 203 in FIG. 6), and the voltage of the bulb load 4 (labeled “Load Voltage” and numbered with the reference number 204 in FIG. 6). As previously noted herein during the discussion of the known dimmer 50, in TRIAC-based dimming systems used in homes having the no-neutral wiring configuration 2, there is an inverse relationship between power supplied to the control circuit of a smart dimmer and the dimming level of the dimmer. In viewing FIG. 6, it can be seen that the maximum dim level auto-adjust feature included in the wi-fi dimmer 100 mitigates the effects of this inverse relationship (as is evident by the stability of the Vrect waveform in FIG. 6), as detailed further hereinafter.

For the sake of clarity, it is noted that the terms “phase angle” or “firing angle” are used herein to denote the delay after each zero-crossing in the AC source voltage signal (the AC source voltage signal being the Main AC signal 201 in FIG. 6) at which the bulb load 4 is turned on, and the term “conduction angle” is used herein to denote the duration for which the bulb load 4 is turned on within each half-cycle of the AC source voltage signal. A higher conduction angle corresponds to the bulb load 4 producing a brighter output. Speaking in general terms, among known smart no-neutral dimmer devices such as the known dimmer 50 depicted in FIG. 3, when a very low power bulb load having high impedance is connected to a smart dimmer device employing TRIAC-based dimming, the current-supplying capability of the dimmer's power supply circuit may not be sufficient to support the dimmer's control circuit when the conduction angle is dimmed to a high level (i.e. when the dim level is set to produce a brighter output by the bulb), causing unstable operation of the dimmer device and flickering of the bulb. The maximum dim level auto-adjust feature included in the wi-fi dimmer 100 prevents these unstable operating conditions and associated flickering of the bulb load 4.

Without a neutral line, the power supply for the control module 107 is only generated when the TRIAC device 113 is OFF, and the peak value of voltage applied to the power supply circuit 120 will decrease when the TRIAC device 113 is ON and the conduction angle increases. The input current of the power supply circuit 120 must flow through the bulb load 4, and a bulb load 4 having a lower power rating with higher impedance will lead to high voltage drop on the bulb load 4 during the off phase of the TRIAC device 113, thus decreasing the input voltage of the flyback (AC-DC) converter 117. The input voltage to the flyback converter 117 should remain higher than a safety threshold value Vthresh to ensure that the flyback converter 117 operates normally and stably at all times and that the control module 107 has sufficient power to operate normally and stably at all times. The controller 103 executes a maximum dim level auto-adjust function by monitoring the input voltage of the flyback converter 117 via the voltage monitor 116 and adjusting the maximum conduction angle/dim level (i.e. the brightest permissible output of the bulb load 4) of the dimmer 100 to ensure that the input voltage to the flyback converter 117 does not drop below the safety threshold value Vthresh.

At certain current consumption levels of the control module 107, ideal peak voltage of the rectified voltage Vrect occurs when the conduction angle is greater than 90°, and voltage drop on the bulb load 4 during the off phase is determined by the input current caused by the control circuit current and the impedance of the bulb load 4. Reference is made once more to FIG. 6 to explain how the wi-fi dimmer 100 behaves with a large conduction angle and a low power/high impedance bulb load 4. The Vrect signal 203 is rectification of the voltage passed by the TRIAC device 113. Ideally, Vrect is the rectification of the phase-cut main AC signal 201 and the phase/firing angle is the supplementary angle of the conduction angle. When the conduction angle is greater than 90°, the ideal maximum value of Vrect (spot a1 in FIG. 6) is decided by the firing angle, as spot a1 shifts as the firing angle shifts. When the conduction angle is less than 90°, the ideal maximum value for Vrect is the peak voltage of the main AC signal 201 (spot a2 in FIG. 6).

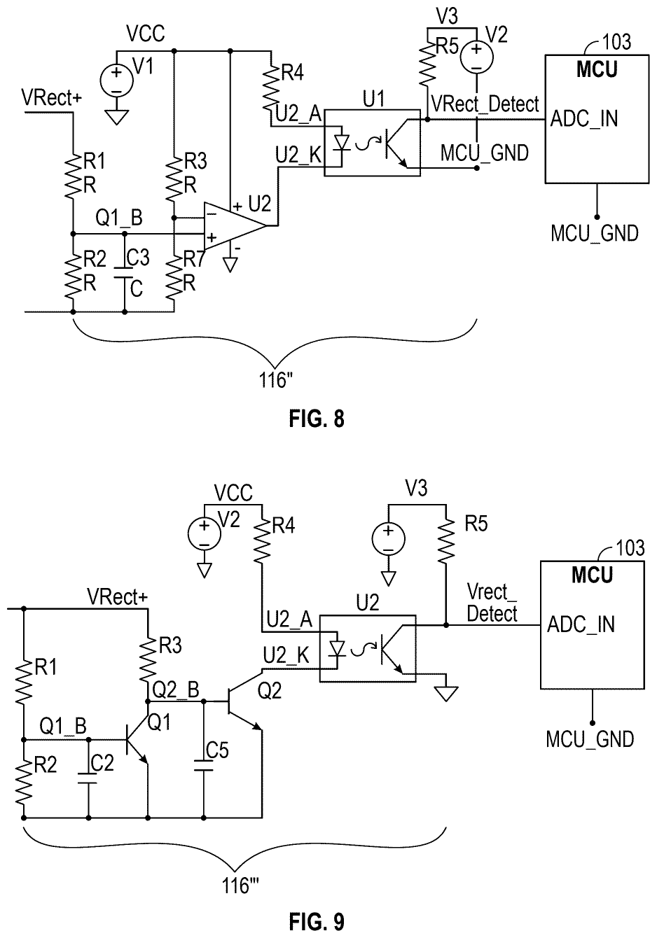

FIGS. 7-9 show three different embodiments 116′, 116″, 116′″ of the voltage monitor circuit 116. Each of the three embodiments can be referred to generally with the reference number 116. The embodiment 116′ shown in FIG. 7 is less costly and slightly less accurate as compared to the embodiments 116″, 116′″ shown in FIGS. 8 and 9. The embodiments 116″, 116′″ shown in FIGS. 8 and 9 are very similar to one another in terms of cost and performance. The embodiment 116′ (FIG. 7) is a non-isolated embodiment wherein the voltage monitor circuit 116 is not electrically isolated from the control module 107. The embodiment 116″ (FIG. 8) is a first isolated embodiment that utilizes a comparator op amp in conjunction with an opto-coupler to electrically isolate the voltage monitor circuit 116 from the control module 107. The embodiment 116′″ (FIG. 9) is a second isolated embodiment that utilizes transistors in conjunction with an opto-coupler to electrically isolate the voltage monitor circuit 116 from the control module 107.

In all three embodiments 116′, 116″, 116′″, voltage dividing resistors are used to divide the high voltage Vrect to a voltage level closer to the relatively low voltage that can be read by the control module 107. The controller 103 monitors the voltage divider output voltage (labeled “Vrect_detect” in FIGS. 7-9), and determines what the flyback input voltage Vrect is based on Vrect_detect. Any time that Vrect decreases to the threshold value Vthresh, the controller 103 will set the maximum dim level of the wi-fi dimmer 100 to correspond to the present conduction angle. In the isolated solutions shown in FIGS. 8 and 9, the reference ground of the control module 107 is isolated with the reference ground of Vrect. The detected Vrect voltage is compared to the safety threshold Vthresh value to trigger either the comparator circuit (FIG. 8) or the transistor circuit (FIG. 9). Once the comparator circuit or transistor circuit is triggered, the status of the output of the opto-coupler reverses, and the controller 103 detects this reversal and sets the present conduction angle as the system's maximum dim level.

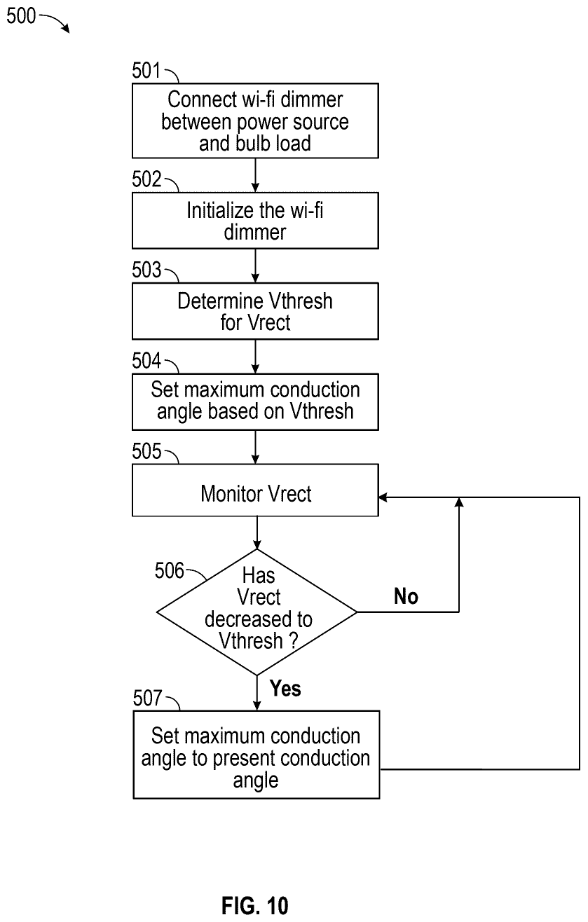

FIG. 10 is a flowchart of a method 500 of dimming a load with a smart dimmer that lacks a direct neutral connection to a power source, in accordance with an example embodiment of the disclosed concept. The method 500 may be employed, for example, with the wi-fi dimmer 100 and is described in conjunction with the wi-fi dimmer 100. However, it will be appreciated that the method may be employed in other devices as well without departing from the scope of the disclosed concept. The method begins at step 501, where the wi-fi dimmer 100 is connected between the power source 3 and the bulb load 4. Connecting the wi-fi dimmer 100 between the power source 3 and the bulb load 4 includes connecting a line terminal of the wi-fi dimmer 100 to the line voltage of the power source 3 via the hot conductor 8A and connecting a load terminal of the wi-fi dimmer 100 to the bulb load 4 via the neutral conductor 8B. It is assumed that the bulb load 4 is already connected to the power source 3 by the neutral conductor 10.

At step 502, the wi-fi dimmer 100 is initialized. Initializing the wi-fi dimmer 100 includes powering on the control module 107. Powering on the control module 107 is achieved by closing the air gap switch 130, which completes the lighting circuit between the power source 3, the wi-fi dimmer 100, and the bulb load 4. Initializing the wi-fi dimmer 100 also includes automatically determining the following three attributes of the lighting circuit with the controller 103 after the controller 103 is powered on: (1) what the current draw of all current-consuming components in the wi-fi dimmer 100 is (the current-consuming components in the wi-fi dimmer 100 being the controller 103 and the wi-fi module 104); (2) what the efficiency of the power supply circuit 110 is; and (3) what the impedance of the bulb load 4 is. As previously noted, these three attributes (collectively referred to hereinafter as the “constant operating attributes”) are assumed to be constant once the wi-fi dimmer 100 and bulb load 4 are correctly wired to one another and to the power source 3. For any given point in time, these three constant operating attributes, along with the operating condition of the wi-fi dimmer 100 at that given point in time, are the primary factors that determine the value of the rectified voltage Vrect at that given point in time, with Vrect being the voltage that determines whether or not the control module 107 will have sufficient power to operate stably.

At step 503, the controller 103 determines the minimum threshold safety value Vthresh for Vrect. As previously discussed, Vthresh is the minimum voltage that the control module 107 requires to operate stably, and Vthresh is determined based on the constant operating attributes determined at step 502. At step 504, the controller 103 sets a maximum conduction angle for the wi-fi dimmer 100 based on the value of Vthresh determined at step 503. As previously discussed, increasing the conduction angle causes a corresponding decrease in Vrect. At step 505, Vrect is monitored. At step 506, the controller 103 determines if Vrect has decreased to Vthresh. If yes, then the method proceeds to step 507, where the maximum conduction angle is set to the present conduction angle. If no, then the method returns to step 505. The method also returns to step 505 after step 507 is completed. Steps 505, 506, and 507 (as applicable) repeat until the wi-fi dimmer 100 is powered off, e.g. by opening the air gap switch 130 or by disconnecting the bulb load 4 from either the power supply 4 or the wi-fi dimmer 100.

### Three-Way Load Control In A Two-Wire No-Neutral Wi-Fi Dimmer System

It will be appreciated that in certain settings, instead of having only a single dimmer device, it is desirable to have a lighting control system comprising multiple lighting load control devices distributed throughout the space. In such systems, the master dimmer is typically the only device that is directly connected to the bulb load, and any additional load control devices are auxiliary devices that can receive user input but do not directly control the bulb load. When an auxiliary device receives user input, the auxiliary device transmits a signal communicating the user input to the master dimmer, and the master dimmer then adjusts the load based on the communicated user input.

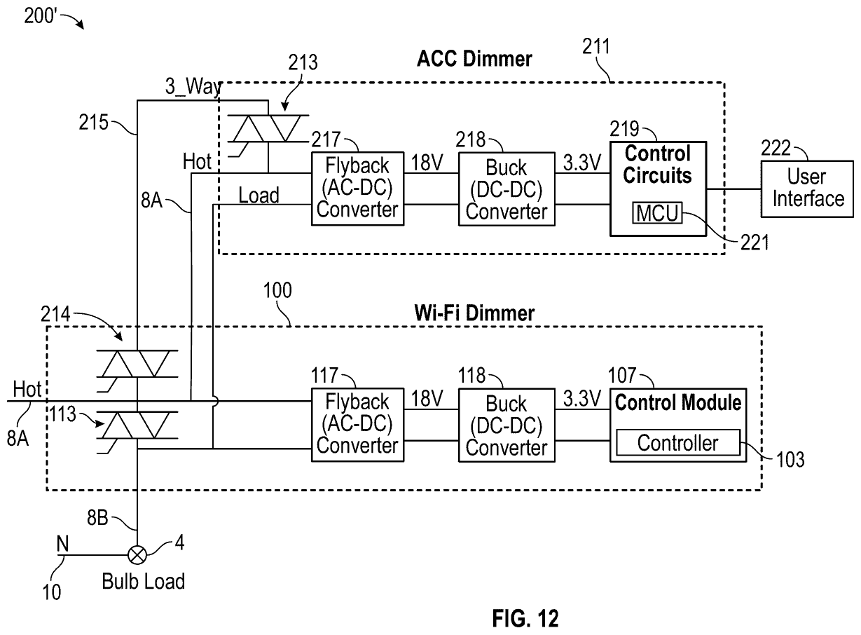

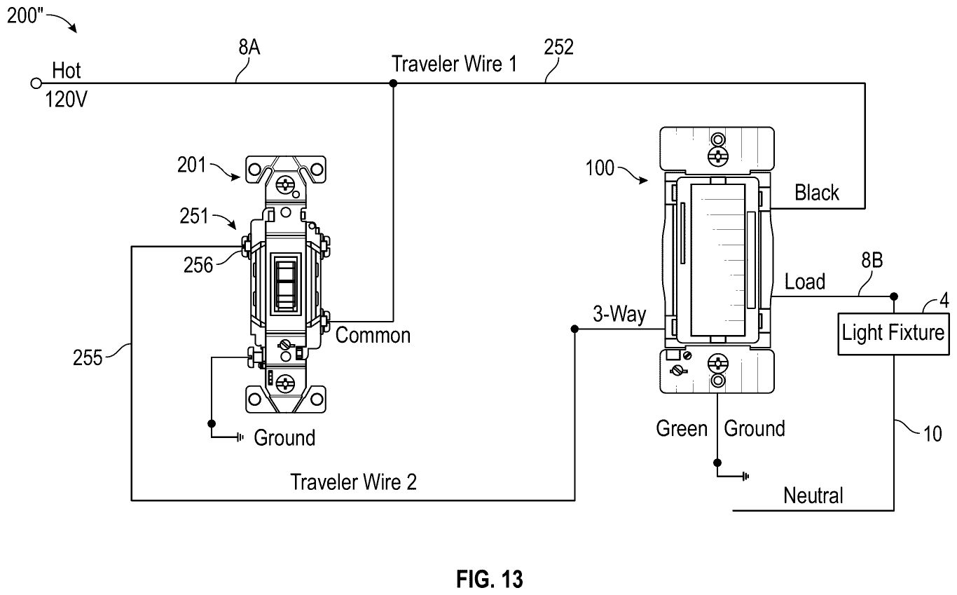

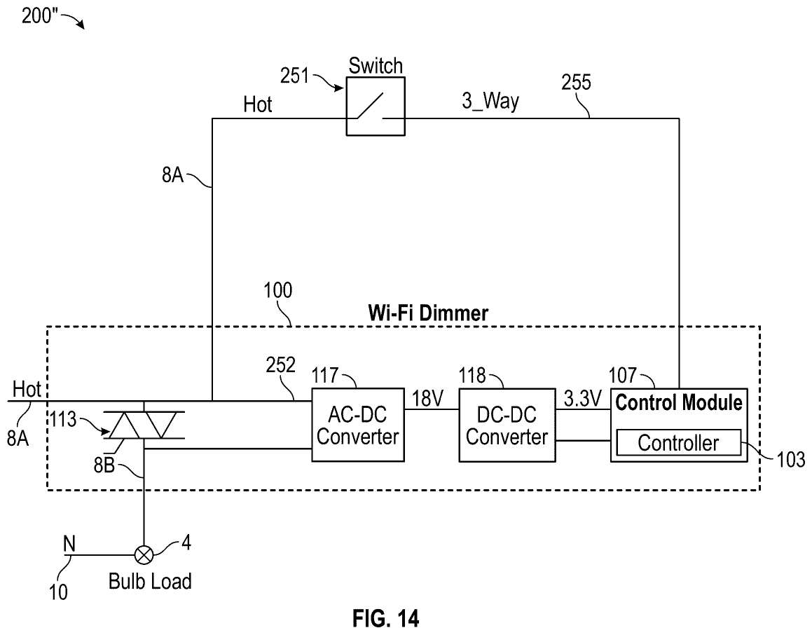

FIGS. 11-14 show an improved dimmer system 200 structured to be installed in homes having the no-neutral wiring configuration 2 and that includes the wi-fi dimmer 100 and an auxiliary load control device 201, in accordance with exemplary embodiments of the disclosed concept. In the dimmer system 200, the wi-fi dimmer 100 is the master dimmer. In detailing the dimmer system 200, the wi-fi dimmer 100 is sometimes referred to hereinafter as the “master dimmer 100”. FIGS. 11-12 are directed to a first embodiment 200′ of the dimmer system 200, where the auxiliary load control device 201 is an improved accessory dimmer 211 that is disclosed in accordance with an exemplary embodiment of the disclosed concept. FIGS. 13-14 are directed to a second embodiment 200″ of the dimmer system 200, where the auxiliary load control device 201 is a three-way switch 251. Both dimmer systems 200′, 200″ can be referred to generally using the reference number 200. The accessory dimmer 211 and the three-way switch 251 can each be referred to generally as the “auxiliary load control device 201”. The architecture of the wi-fi dimmer 100 is depicted in a streamlined manner in FIGS. 12 and 14 for simplicity, but it should be understood that the wi-fi dimmer 100 shown in FIGS. 11-14 has the same architecture as depicted in FIG. 5. In the dimmer systems 200′, 200″, the wi-fi dimmer 100 functions in the same manner previously described in conjunction with FIGS. 5-10.

The dimmer system 200′ will now be detailed in conjunction with FIGS. 11-12. In the dimmer system 200′, the accessory dimmer 211 provides an additional interface through which a user can input their desired dimming level, which the accessory dimmer 211 then communicates to the wi-fi dimmer 100. That is, the accessory dimmer 211 cannot directly adjust the dimming level of the bulb load 4 and can only direct the wi-fi dimmer 100 to adjust the dimming level of the bulb load 4.

In the dimmer system 200′, the hot conductor 8A is connected between the power source 3 (not shown in FIGS. 11-12) and the line side of the accessory dimmer 211. As shown in FIG. 12, an accessory-side traveler TRIAC 213 is connected at a first end to the line side of the accessory dimmer 211, a master-side traveler TRIAC 214 is connected at a first end to the line side of the master dimmer 100, and a traveler wire 215 connects the second end of the accessory-side traveler TRIAC 213 to the second end of the master-side traveler TRIAC 214. The load side of the accessory dimmer 211 is connected to the load side of the master dimmer 100 and thus to the load conductor 8B passing through the bulb load 4.

Similar to the wi-fi dimmer 100, the accessory dimmer 211 includes a flyback (AC-DC) converter 217, a buck (DC-DC) converter 218, and a number of control circuits 219. The flyback converter 217 and buck converter 218 function similarly to the flyback converter 117 and buck converter 118, and the non-limiting illustrative examples of 18V for the first step down DC voltage and 3.3V as the lower output second step down DC voltage in the accessory dimmer 211 are provided in FIG. 12. Connecting the load side of the accessory dimmer 211 to the load conductor 8B that passes through the bulb load 4 supplies power to the accessory dimmer 211 that is required by its control circuits 219. While the accessory dimmer 211 does not include a wi-fi module, it does include a controller 221 that can constitute a microcontroller, for example and without limitation. The control circuits 219 are configured to receive user input via a user interface 222. As explained hereinafter, the accessory controller 221 cannot directly control dimming of the bulb load 4 based on user input received via the user interface 222. Instead, the accessory controller 221 transmits signals to the master controller 103 based on the input to the user interface 222. The user interface 222 can include, for example and without limitation, a dimming button that enables a user to manually transmit a request to the accessory controller 221 to adjust the dimming level of the bulb load (i.e. manually transmitting by holding down the button to indicate a desire to either increase or decrease in brightness) or an interface that enables a user to select from various scheduling or grouping functions that the controller 103 is configured to run.

When the accessory controller 221 receives user input, the controller 221 transmits a signal representative of the user input via the accessory-side traveler TRIAC 213 to the controller 103 of the wi-fi dimmer 100, and the controller 103 executes the actions necessary to effectuate the change to the bulb load 4 that is requested by the accessory-side user input. In particular, when a user provides dimming or ON/OFF commands to the accessory controller 221, the controller 221 changes the gate input to the accessory-side traveler TRIAC 213 to communicate the user commands along the traveler wire 215 to the master dimmer 100 via the master-side TRIAC 214. The controller 221 can change the gate input to the accessory-side traveler TRIAC 213 in order to transmit requests to the master controller 103 to change the dimming level. The master controller 103 can change the gate input to the master-side TRIAC 214 in order to transmit messages to the accessory controller 221.

The dimmer system 200″ will now be detailed in conjunction with FIGS. 13-14. In the dimmer system 200″, the three-way switch 251 provides an additional manner in which the bulb load 4 can be turned on and off. It should be noted that the three-way switch 251 is not capable of controlling dimming of the bulb load 4 in any way.

In the dimmer system 200″, the hot conductor 8A is connected between the power source 3 (not shown in FIGS. 13-14) and the line side of the three-way switch 251, while a hot traveler wire 252 connects the line side of the wi-fi dimmer 100 to the hot conductor 8A. A second traveler wire 255 connects a three-way terminal 256 of the three-way switch 251 to the control module 107 of the master dimmer 100. The second traveler wire 255 is the only traveler wire connected between the three-way terminal 256 of the three-way switch 251 and the control module 107, and the remaining three-way terminal of the three-way switch 251 is connected to ground. As such, when the three-way switch 251 is open, the connection between the bulb load 4 and the power source 3 is open and the bulb load 4 is off, regardless of what the settings of the wi-fi dimmer 100 are. When the three-way switch 251 is closed, the connection between the bulb load 4 and the power source 3 is closed, and the dimming level of the bulb load 4 can be controlled by the wi-fi dimmer 100.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A smart dimmer structured to be connected between a power source that provides an AC source voltage signal and a bulb load that produces light, the bulb load being connected to the power source by a neutral conductor, the smart dimmer comprising:
a control board that includes a control module, the control module comprising:
a controller; and
a wi-fi module;
a power board having a line side and a load side, the power board being structured to receive the AC source voltage signal as input to its line side and to be connected at its load side to the bulb load, the power board comprising:
a zero-crossing detection circuit;
a TRIAC gate control;
a TRIAC device;
a snubber circuit configured to receive the AC source voltage signal as input and to output a transient-suppressed voltage signal;
a bridge rectifier configured to receive the transient-suppressed voltage signal as input and to rectify the transient-suppressed voltage signal to produce a rectified voltage signal Vrect;
a rectified voltage monitor circuit configured to determine the magnitude of Vrect;
a flyback converter configured to receive Vrect as input and to output a flyback DC signal; and
a buck converter configured to receive the flyback DC signal as input and produce a DC supply signal to power the control module; and
a board to board connector that connects the control board to the power board,
wherein the zero-crossing detection circuit, the rectified voltage monitor circuit, and the buck converter are all configured to provide input signals to the controller, and
wherein the controller is configured to:
set a dimming level for the bulb load,
detect zero crossings in the AC source voltage signal, and
provide input signals to the TRIAC gate control to turn on and turn off the TRIAC device at specific points after the zero crossings in order to cause current to flow to the bulb load to produce a light output corresponding to the dimming level.

2. The smart dimmer of claim 1,
wherein the controller is configured to ensure that Vrect does not fall below a minimum threshold voltage level Vthresh,
wherein Vthresh is the minimum voltage required for the control module to operate stably.

3. The smart dimmer of claim 2,
wherein the controller is configured such that, when Vrect equals Vthresh, the controller determines the present conduction angle corresponding to Vrect being equal to Vthresh and sets a maximum dim level to correspond to the present conduction angle,
wherein the controller is configured to prevent the dimming level from exceeding the maximum dim level.

4. The smart dimmer of claim 1,
wherein the power board is configured such that increasing the dimming level decreases voltage supplied to the flyback converter, and
wherein the controller is configured to ensure that the dimming level does not exceed a maximum threshold dim level.

5. The smart dimmer of claim 1,
wherein the flyback converter is structured such that the flyback DC signal is an 18V signal,
wherein the buck converter is structured such that the DC supply signal is a 3.3V signal.

6. The smart dimmer of claim 1, wherein the flyback DC signal is stepped down in magnitude from Vrect.

7. The smart dimmer of claim 6,
wherein the DC supply signal is stepped down in magnitude from the flyback DC signal.

8. A method of dimming a bulb load with a smart dimmer in a lighting circuit; the lighting circuit including a power source, a bulb load, and the smart dimmer; the bulb load being connected to the power source via a neutral conductor; the smart dimmer not being structured to have a direct neutral connection to the power source while connected to the bulb load; the method comprising:
connecting the smart dimmer between the power source and the bulb load, by connecting a line terminal of the smart dimmer to line voltage of the power source and by connecting a load terminal of the smart dimmer to the bulb load,
initializing the smart dimmer, wherein the initializing includes:
closing an electrical path between the power source, the bulb load, and a control module of the smart dimmer, the control module including a controller; and
determining a number of constant operating attributes of the lighting circuit with the controller;
determining, with the controller, a minimum threshold safety value Vthresh for a rectified voltage Vrect produced in the smart dimmer, with Vthresh being the minimum value that Vrect can take that enables the control module to operate stably;
setting, with the controller, a maximum conduction angle for smart dimmer based on the value of Vthresh;
monitoring Vrect with the controller;
determining, with the controller, if Vrect has decreased to Vthresh; and
setting the maximum conduction angle to the present value of Vrect when Vrect decreases to Vthresh.

9. The method of claim 8,
wherein the control module includes an on-board wi-fi module that enables a user to remotely provide input to the controller via wireless communication.

10. The method of claim 8,
wherein the smart dimmer is structured such that Vthresh is inversely proportional to the maximum conduction angle.

11. The method of claim 8,
wherein the number of constant operating attributes includes the current draw of the control module.

12. The method of claim 9,
wherein the number of constant operating attributes includes the current draw of the control module.

13. The method of claim 8,
wherein the number of constant operating attributes includes the efficiency of a power supply circuit of the smart dimmer, the power supply circuit being circuitry of the smart dimmer that converts the line voltage to a stepped-down supply voltage used to power the control module.

14. The method of claim 8,
wherein the number of constant operating attributes includes the impedance of the bulb load.
